(19) United States
(12) Patent Application Publication
(10) Pub. No.: US 2002/0003549 A1
(43) Pub. Date: Jan. 10, 2002

(54) Printing paper regeneration apparatus

(75) Inventor: Masashige Mitsuhashi, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/879,308

(22) Filed: Jun. 12, 2001

(30) Foreign Application Priority Data
Jun. 23, 2000 (JP) 2000-189896

(51) Int. Cl. B41J 3/00

(52) U.S. Cl. 347/2

(57) ABSTRACT

A printing paper regeneration apparatus permits regeneration process of used paper including confidential document within a general office at low running cost. The printing paper regeneration apparatus includes a printing paper regeneration processing portion, and a paper feeding portion supplying printing paper printed by a printer or a copy machine, to the printing paper regeneration processing portion at a given speed. The printing paper regeneration processing portion is constructed by arranging a heating mechanism for heating printing paper, a printing material removing mechanism for removing printing material from the heated printing paper and a printing material and paper dust collecting mechanism for collecting removed printing material and paper dust, in sequential order.

### BACKGROUND OF THE INVENTION

1. Field of the Invention

The present invention relates to a printing paper regeneration apparatus which can erase portion printed on a printing paper by a printer, OA equipment and so forth in a short period and thus can regenerate the printing paper at low running cost.

2. Description of the Related Art

Volume consumption of printing paper associating with spreading of OA equipments would results in destruction of forests. As a measure for this program, it has been required to regenerate used paper printed by the printer, OA equipments, such as copy machine or the like.

The used paper regeneration process by dissolution of the used paper, and bleaching the same currently costs higher than manufacturing of new paper. On the other hand, in office, endowed institution and the like, there are lots of confidential documents. Therefore, it has been strongly demanded for a printing paper regeneration apparatus which can regenerate the used paper in the office in a short period and at low cost to permit printing of new information.

As a prior art of the printing paper regeneration apparatus for installation in the office, as shown in FIG. 5, there is an apparatus, in which a peeling liquid 52 is applied to the printing paper surface 51 to weaken adhering strength between a toner 53 as coloring resin powder and a printing paper 54, and then toner 53 is molten by heating a heater 55, then, the molten toner is transferred to peeling rollers 56 and 57 to sweep off the toner 53 to eject regenerated blank paper.

However, in the foregoing conventional apparatus, regeneration process speed is low (about 20 sec./sheet for A4 paper). Also, due to use of peeling liquid and exchanging of peeling rollers, running cost becomes inherently high.

### SUMMARY OF THE INVENTION

The present invention has been worked out in view of the problem set forth above. It is therefore an object of the present invention to provide a printing paper regeneration apparatus which permits regeneration process of used paper including confidential document within a general office at low running cost.

According to one aspect of the present invention, a printing paper regeneration apparatus comprises:

a printing paper regeneration processing portion;

a paper feeding portion supplying printing paper printed by a printer or a copy machine, to the printing paper regeneration processing portion at a given speed;

the printing paper regeneration processing portion constructed by arranging a heating mechanism for heating printing paper, a printing material removing mechanism for removing printing material from the heated printing paper and a printing material and paper dust collecting mechanism for collecting removed printing material and paper dust, in sequential order.

The printing material removing mechanism may have a roller form grinding stone formed with a groove on the outer peripheral surface thereof. The groove forms an angle less than or equal to 89° relative to an axial direction of the roller form grinding stone. Cross sectional shape of the groove provided on the grinding stone is tapered to widen toward grinding stone working surface.

The printing material removing mechanism may include a pressure roller and an abrasive belt, in which a plurality of holes are provided in the abrasive belt surface.

The printing material and paper dust collecting mechanism may be a printing material and paper dust collecting adhesive tape, a pressure roller and a tape take-up roller. The printing material and paper duct collecting mechanism may be provided with a plurality of suction holes, and a printing material and paper dust suction body is provided for sucking and collecting the printing material and paper dust through a fine gap by suction of air from the suction holes. The fine gap may be less than or equal to 1 mm.

The printing material removing mechanism and a printing material and paper dust collecting mechanism may be formed as an integrated mechanism. The integrated mechanism may be provided with a large number of printing mechanism and paper dust collecting holes extending from the outer peripheral surface to the inner peripheral surface of a cylindrical grinding stone, a through hole corresponding to the printing material and paper dust collecting holes of the grinding stone in a hollow bearing rotation simultaneously with holding the inner periphery of the grinding stone, and a suction groove is provided on a non-rotatable center shaft arranged within the hollowing bearing at a position corresponding to a printing paper scraping point of the grinding stone. The integrated mechanism may be formed by providing a spiral or grating form groove on a disc surface pf a disc shaped grinding stone, a plurality of printing material and paper dust suction holes are provided in a bottom surface of the groove.

The heating mechanism may be formed into a roller form, and is placed in contact with a paper surface for heating. The heating mechanism may heat the paper surface at a temperature in a range of 40° C. to 90° C.

The paper feeding portion may have a detection mechanism for detecting presence and absence of print on the printing paper surface. The detection mechanism may have a laser diode irradiating a printing paper surface and a fiber sensor receiving a reflected light from the printing paper surface.

The printing paper regeneration apparatus may further comprise a printing portion for printing information again on the printing paper regenerated by the printing paper regeneration processing portion. The paper feeding portion may have a detection mechanism for detecting presence and absence of print on the printing paper surface, and the apparatus further comprises a direct feeding mechanism for directly feeding the printing paper to the printing portion bypassing the printing paper regeneration processing portion when the detection mechanism detects absence of print on the printing paper surface.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is an illustration showing an arrangement for explaining overall construction of the first embodiment of a printing paper regeneration apparatus according to the present invention;

FIG. 2 is a side elevation showing a construction of a printing paper regeneration processing portion of the first embodiment of the printing paper regeneration apparatus;

FIG. 3 is a side elevation showing a construction of the printing paper regeneration processing portion of the second embodiment of the printing paper regeneration apparatus according to the present invention;

FIG. 4 is an enlarge partial side elevation of acylindrical grinding stone, a through hole of a hollow bearing and a suction groove of a center shaft in the printing paper regeneration processing portion in the second embodiment of printing paper regeneration apparatus; and

FIG. 5 is a side elevation for explaining a printing paper regeneration processing portion in the conventional printing paper regeneration apparatus.

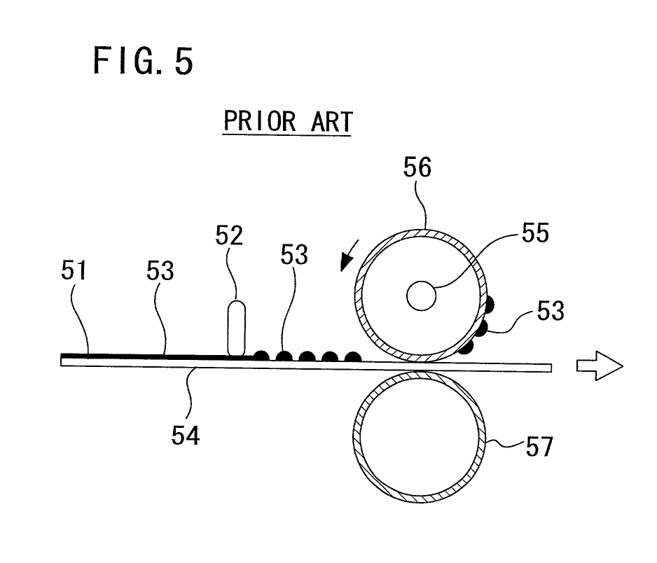

### DESCRIPTION OF THE PREFERRED EMBODIMENT

The present invention will be discussed hereinafter in detail in terms of the preferred embodiment of a printing paper regeneration apparatus of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structure are not shown in detail in order to avoid unnecessary obscurity of the present invention.

First Embodiment

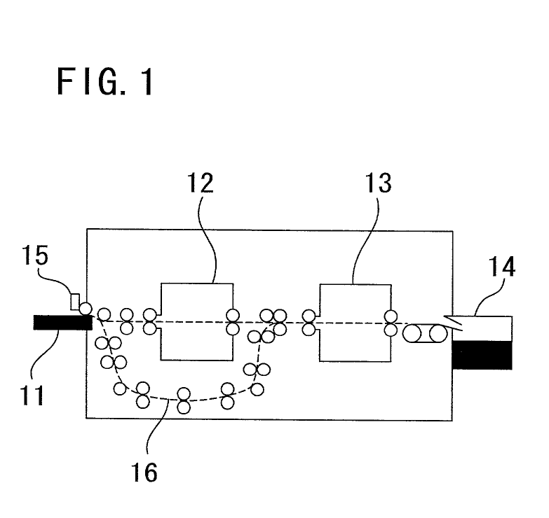

FIG. 1 is a general illustration of the overall construction of the first embodiment of a printing paper regeneration apparatus according to the present invention.

In FIG. 1, the shown embodiment the printing paper regeneration apparatus is constructed with a paper feeding portion 11, a printing paper regeneration processing portion 12, an information printing process portion 13 and a printing paper receiving portion 14. In the paper feeing portion 11, an optical fiber sensor 15 is arranged in opposition to a printing paper surface of a printing paper. The optical fiber sensor 15 is constructed with a laser diode irradiating a laser beam on the printing paper surface and a fiber sensor receiving a reflected light from the printing paper surface. A direct paper feeding mechanism 16 is also provided for directly feeding a printing paper to information printing processing portion 13. The information printing process portion 13 performing a printing process on the printing paper by a printing material, such as toner, ink or the like.

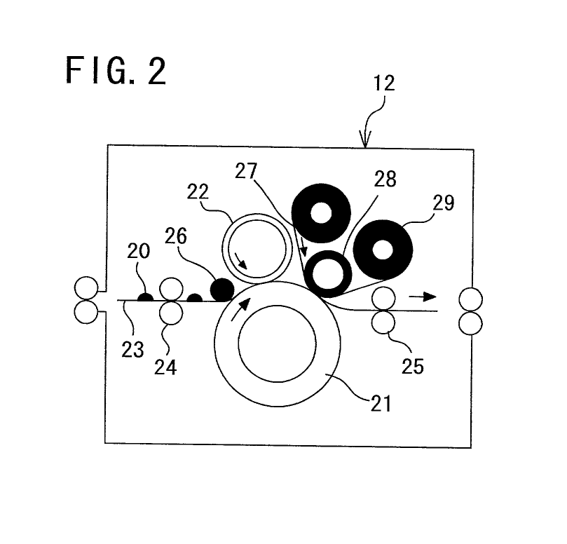

FIG. 2 is a side elevation showing a construction of the printing paper regeneration processing portion 12 in the printing paper regeneration apparatus shown in FIG. 1.

In FIG. 2, an elastic body roller 21 and a roller form grinding stone 22 are arranged in opposition to each other. On upstream side and downstream side of the mutually opposing elastic body roller 21 and the roller form grinding stone 22, paper feeding rollers 24 and 25 are arranged. Between the paper feeding roller 24 and the roller form grinding stone 22, a roller form heating mechanism 26 is arranged. On the other hand, between the roller form grinding roller 22 and the paper feeding roller 25, a printing material and paper dust collecting adhesive tape 27, a pressure roller 28 a tape take up roller 29 are arranged. The roller form heating mechanism 26, the roller form grinding stone 22 and the printing material and paper dust collecting adhesive tape 27 contact with the elastic body roller 21 via a printing paper 23 at a given pressure. The roller form heating mechanism 26 preferably heats the printing paper 23 at a temperature of 40° C. to 90° C. If the heating temperature becomes 100° C. or higher, moisture is evaporated to cause solidification of the printing material. On the other hand, 40° C. means the heating temperature is higher than a room temperature in summer season.

A groove forming a predetermined angle relative to axial direction is provided on the outer peripheral surface of the roller form grinding stone 22. The groove is formed into a tapered groove widened from the bottom toward the opening end. By providing the groove on the outer peripheral surface of the roller form grinding stone 22, the printing material and paper dust floated by abrasive grain of the grinding stone temporarily enter into the groove and thus can prevent the printing material and paper dust from being buried into the printing paper surface. In addition, by forming the groove into the tapered groove, the printing material and paper dust floated by the grinding stone can be easily fallen into the groove. Preferably, the groove is formed at an angle less than or equal to 89° relatively the axial direction of the roller form grinding stone. Namely, the groove is formed at an angle smaller than 90° (right angle) relative to the axial direction of the roller form grinding stone 22.

Next, operation will be discussed.

By the optical fiber sensor 15 arranged in the paper feeding portion 11, presence of absence of print on the printing paper surface is detected. When print is present, the printing paper 23 is supplied to the printing paper regeneration processing portion 12. When print is not present, the printing paper 23 is directly supplied from the paper feeding portion 11 to the information printing processing portion 13 through the direct paper feeding mechanism 16.

In the printing paper regenerating process portion 12, the printing paper 23 printed with the printing material 20, such as toner, ink or the like is heated to a predetermined temperature by the roller form heating mechanism 26 to soften the printing material 20 to facilitate removal. Thereafter, through the rotating roller form grinding stone 22 and the elastic body roller 21, the printing material 20 is scraped off for erasure. The printing material 20 and paper dust scraped off is collected by adhering on the printing material and paper dust collecting adhesive tape 27. The regenerated printing paper is supplied to the information printing processing portion 13 to perform information printing, and then received in the printing paper receiving portion 14.

Accordingly, after softening the printing material 20 by the roller form heating mechanism 26 for facilitating removal, the roller form grinding stone 22 is driven to rotate at high speed for scraping off the printing material 20 printed on the printing paper 23 at short period to perform printing paper regeneration process. The scraped printing material 20 and the paper dust is adhered on the printing material and paper dust collecting adhesive tape 27 and is collected by the taper take up roller 29. Therefore, the printing paper regeneration apparatus having higher processing speed and lower running cost as compared with the prior art, can be obtained.

It should be noted that while the foregoing embodiment includes the printing material removing mechanism with the roller form grinding stone 22, the printing material removing mechanism may be constructed with a pressure roller and an abrasive belt which is formed with a plurality of through holes. By this, the printing material and the paper dust floated by abrasive grain on the belt surface temporarily enter into the belt holes and thus can prevent the printing material and paper dust from being buried into the printing paper surface.

On the other hand, in the shown embodiment, the printing material and paper dust collecting mechanism includes the printing material and paper dust collecting adhesive tape 27, the pressure roller 28 and the tape take up roller 29. However, the printing material and the paper dust collecting mechanism may have the printing material and paper dust suction body having a suction surface provided with a plurality of suction holes and arranged within a fine gap between the printing paper surface and the abrasive belt surface or the roller form grinding stone surface, and sucking and collecting the printing material and the paper dust by suction force of the air. Here, unless the fine gap is less than or equal to 1 mm, suction collecting force may not act effectively.

Second Embodiment

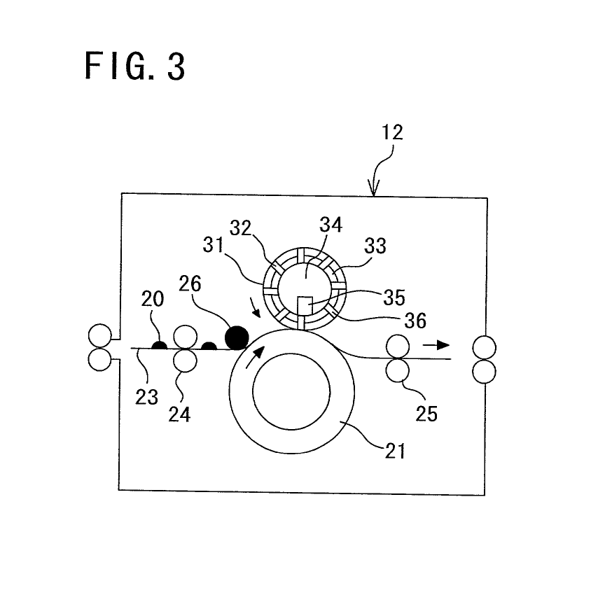

FIG. 3 is a side elevation showing the printing paper regenerating portion 21 in the second embodiment of the printing paper regenerating apparatus according to the present invention. The shown embodiment of the printing paper regenerating apparatus has similar components to those in the first embodiment except for the printing paper regeneration processing portion 21. On the other hand, in the following discussion, the components similar to the first embodiment will be identified by the same reference numerals and discussion therefor will be eliminated.

In FIG. 3, the elastic body roller 21 and a cylindrical grinding stone 31 are arranged in opposition with each other. On upstream side and downstream side of the elastic body roller 21 and the cylindrical grinding stone 31, the paper feeding rollers 24 and 25 are arranged. Between the paper feeding roller 24 and the cylindrical grinding stone 31, the roller form heating mechanism 26 is arranged. The roller form heating mechanism 26 and the cylindrical grinding store 31 contacts with the elastic body roller 21 via the printing paper 23 at a given pressure.

From the outer periphery to the inner periphery of the cylindrical grinding stone 31, printing material and paper dust collecting holes 32 are provided. In a follow bearing 33 holding the inner periphery of the cylindrical grinding stone 31 and rotating simultaneously, a through hole 36 corresponding to the printing material and paper dust collecting hole 32 of the cylindrical grinding stone 31 is provided. Also, corresponding to a printing paper scraping point position of the cylindrical grinding stone 31, a suction groove 35 is formed on a non-rotatable center shaft 34 arranged on inside of the hollow bearing 33.

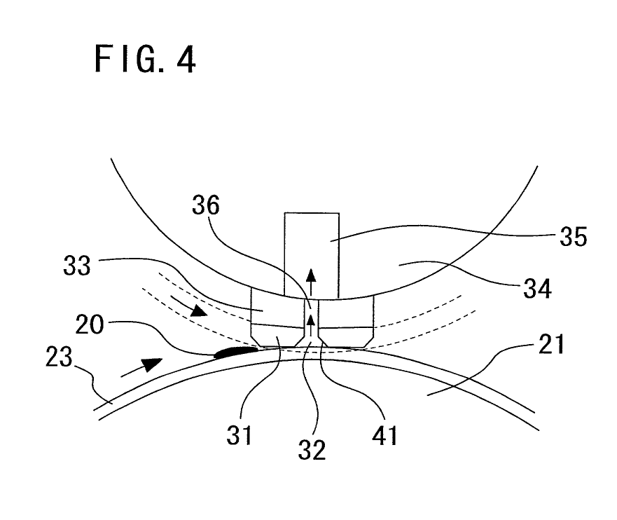

FIG. 4 is an enlarged partial side elevation of the cylindrical grinding stone 31, the portion of the through hole 36 of the hollow bearing 33 and the suction groove of the center shaft 34. In FIG. 4, the through hole 36 is continuous with a tapered groove 41 having an opening portion on the outer peripheral surface of the cylindrical grinding stone 31.

Next, operation will be discussed.

By the optical fiber sensor 15 arranged in the paper feeding portion 11, presence of absence of print on the printing paper surface is detected. When print is present, the printing paper 23 is supplied to the printing paper regeneration processing portion 21. When print is not present, the printing paper 23 is directly supplied from the paper feeding portion 11 to the information printing processing portion 13 through the direct paper feeding mechanism 16.

In the printing paper regenerating process portion 21, the printing paper 23 printed with the printing material 20, such as toner, ink or the like is heated to a predetermined temperature by the roller form heating mechanism 26 to soften the printing material 20 to facilitate removal. Thereafter, through the rotating cylindrical grinding stone 31 and the elastic body roller 21, the printing material 20 is scraped off for erasure. The printing material 20 and paper dust scraped off is sucked and collected through the tapered groove 41, the through hole 36 and the suction groove 35. The regenerated printing paper is supplied to the information printing processing portion 13 to newly perform information printing and then received in the printing paper receiving portion 14.

Accordingly, after softening the printing material 20 by the roller form heating mechanism 26 for facilitating removal, the cylindrical grinding stone 31 is driven to rotate at high speed for scraping off the printing material 20 printed on the printing paper 23 at short period to perform printing paper regeneration process. The scraped printing material 20 and the paper dust sucked and collected through the tapered groove 41, the through hole 36 and the suction groove 35. Therefore, the printing paper regeneration apparatus having higher processing speed and lower running cost as compared with the prior art, can be obtained. Furthermore, in the shown embodiment, since the printing material removal and the printing material and paper dust collecting function are done by an integrated mechanism. Therefore, down-sizing of the apparatus and paper dust collecting efficiency can be improved.

It should be noted that in the shown embodiment, the mechanism in which the printing material removal and the printing material and paper dust collecting function are integrated, is the cylindrical grinding stone 31. However,the cylindrical grinding stone 31 can be replaced with the disc shaped grinding stone. In such case, spiral or grid form groove is formed on the surface of the disc shaped grinding stone and a plurality of printing material and paper dust suction holes are formed in the bottom of the groove. By this, the printing material and paper dust floated by abrasive grain of the grinding stone enters into the groove and collected through the suction hole to contribute for down-sizing of the apparatus and improvement of printing material and paper dust collection efficiency.

It should be noted that in the shown embodiment, the present invention is not limited to the printing paper regeneration apparatus, and is applicable of any printing paper regeneration apparatus suitable for application of the present invention. As one example, the printing paper is not limited to the plain paper but can be glossy paper, drawing paper and other thick paper.

On the other hand, number, position, shape and so forth of the foregoing components should not be limited to those in the foregoing embodiment, and can be any number, position, shape and so forth suitable for implementing the present invention.

It should be noted that in various drawings, like components are identified by like reference numerals.

The followings are results of particular test performed in connection with the foregoing first and second embodiments.

First Embodiment

Particular test result corresponding to the first embodiment will be discussed.

Test was performed by regenerating a sample printed alphabetic characters over the entire surface of a plain paper (A4 size, 70 μm thick) with toner by means of a laser printer, and by subsequently performing printing.

In the printing paper regenerating process portion 12, the printing paper 23 printed with the toner (printing material) is passed between the roller form grinding stone (25 mm in diameter, diamond abrasive grain of grain size 150μ) 22 rotating at 1200 r.p.m. and the elastic body roller (45 mm in diameter) 21 rotating at 60 r.p.m. to scrape off the toner (printing material) under pressure (200 g/cm²). On the outer peripheral surface of the roller form grinding stone 22, the tapered groove having opening 2 mm in opening width, 1 mm in bottom width and 1 mm in depth with forming an angle of 10° relative to the axial direction.

In case of toner print by the laser printer, the print could be erased at scraping depth of 10 μm in paper thickness. The scraped printing material and paper dust were collected by adhering on the printing material and paper dust collecting adhesive tape 27. The regenerated printing paper is supplied to the information printing processing portion 13 to again perform new information processing and thereafter received within the printing paper receiving portion 14.

The printing quality of the printing paper again printed the information has not difference with a bland new printing paper to have no problem as material. A processing period in the printing paper regeneration processing portion is about 3 seconds/sheet, which is about seven times higher process speed in comparison with the conventional apparatus. Wearing of the diamond abrasion is little to lower running cost for capacity of regeneration of large amount of printing papers.

Second Embodiment

Particular test result will be discussed corresponding to the second embodiment.

Test was performed by regenerating a sample printed alphabetic characters over the entire surface of a plain paper (A4 size, 70 μm thick) with toner by means of a laser printer, and by subsequently performing printing.

The printing material and paper dust collecting holes extending from the outer peripheral surface to the inner peripheral surface of the cylindrical grinding stone 31 were provided at a pitch of 8 mm. In a follow bearing 33 holding the inner periphery of the cylindrical grinding stone 31 and rotating simultaneously, a through hole 36 (1mm) corresponding to the printing material and paper dust collecting hole 32 of the cylindrical grinding stone 31 was provided. Also, corresponding to a printing paper scraping point position of the cylindrical grinding stone 31, a suction groove 35 (10 mm of groove width) was formed on a non-rotatable center shaft 34 arranged on inside of the hollow bearing 33. The through hole 36 was arranged in continuation with the tapered groove 41 (2 mm of groove opening end, 1 mm of bottom width and 1 mm of depth) which has opening portion on the outer peripheral surface of the cylindrical grinding stone 31.

In the printing paper regenerating process portion 12, the printing paper 23 printed with the toner (printing material) is passed between the cylindrical grinding stone (25 mm in diameter, diamond abrasive grain of grain size 150μ) 31 rotating at 1800 r.p.m. and the elastic body roller (45 mm in diameter) 21 rotating at 90 r.p.m. to scrape off the toner (printing material) under pressure (200 g/cm²). In case of toner print by the laser printer, the print could be erased at scraping depth of 10 μm in paper thickness. The scraped printing material and paper dust were collected through the tapered groove 41, the through hole 36 and the suction groove 35. The regenerated printing paper is supplied to the information printing processing portion 13 to again perform new information processing and thereafter received within the printing paper receiving portion 14.

The printing quality of the printing paper again printed the information has not difference with a bland new printing paper to have no problem as material. A processing period in the printing paper regeneration processing portion is about 2 seconds/sheet, which is about ten times higher process speed in comparison with the conventional apparatus. Wearing of the diamond abrasion is little to lower running cost for capacity of regeneration of large amount of printing papers.

As set forth above, used paper, such as confidential document or the like in general business office can be regenerated in a short period. The printing paper regeneration apparatus with low running cost can be realized.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. A printing paper regeneration apparatus comprising:
a printing paper regeneration processing portion;
a paper feeding portion supplying printing paper printed by a printer or a copy machine, to said printing paper regeneration processing portion at a given speed;
said printing paper regeneration processing portion constructed by arranging a heating mechanism for heating printing paper, a printing material removing mechanism for removing printing material from the heated printing paper and a printing material and paper dust collecting mechanism for collecting removed printing material and paper dust, in sequential order.

2. A printing paper regeneration apparatus as set forth in claim 1, wherein said printing material removing mechanism has a roller form grinding stone formed with a groove on the outer peripheral surface thereof.

3. A printing paper regeneration apparatus as set forth in claim 2, wherein said groove forms an angle less than or equal to 89° relative to an axial direction of said roller form grinding stone.

4. A printing paper regeneration apparatus as set forth in claim 1, wherein said printing material removing mechanism includes a pressure roller and an abrasive belt, in which a plurality of holes are provided in the abrasive belt surface.

5. A printing paper regeneration apparatus as set forth in claim l, wherein said printing material and paper dust collecting mechanism is a printing material and paper dust collecting adhesive tape, a pressure roller and a tape take-up roller.

6. A printing paper regeneration apparatus as set forth in claim 1, wherein said printing material and paper duct collecting mechanism is provided with a plurality of suction holes, and a printing material and paper dust suction body is provided for sucking and collecting the printing material and paper dust through a fine gap by suction of air from said suction holes.

7. A printing paper regeneration apparatus as set forth in claim 6, wherein said fine gap is less than or equal to 1 mm.

8. A printing paper regeneration apparatus as set forth in claim 1, wherein said printing material removing mechanism and a printing material and paper dust collecting mechanism are formed as an integrated mechanism.

9. A printing paper regeneration apparatus as set forth in claim 8, wherein said integrated mechanism is provided with a large number of printing mechanism and paper dust collecting holes extending from the outer peripheral surface to the inner peripheral surface of a cylindrical grinding stone, a through hole corresponding to the printing material and paper dust collecting holes of said grinding stone in a hollow bearing rotation simultaneously with holding the inner periphery of said grinding stone, and a suction groove is provided on a non-rotatable center shaft arranged within said hollowing bearing at a position corresponding to a printing paper scraping point of said grinding stone.

10. A printing paper regeneration apparatus as set forth in claim 8, wherein said integrated mechanism is formed by providing a spiral or grating form groove on a disc surface pf a disc shaped grinding stone, a plurality of printing material and paper dust suction holes are provided in a bottom surface of said groove.

11. A printing paper regeneration apparatus as set forth in claim 1, wherein said heating mechanism is formed into a roller form, and is placed in contact with a paper surface for heating.

12. A printing paper regeneration apparatus as set forth in claim 11, wherein said heating mechanism heats the paper surface at a temperature in a range of 40° C. to 90° C.

13. A printing paper regeneration apparatus as set forth in claim 2, wherein a cross sectional shape of the groove provided on said grinding stone is a tapered form widened toward a grinding stone working surface.

14. A printing paper regeneration apparatus as set forth in claim 1, wherein said paper feeding portion has a detection mechanism for detecting presence and absence of print on the printing paper surface.

15. A printing paper regeneration apparatus as set forth in claim 14, wherein said detection mechanism has a laser diode irradiating a printing paper surf ace and a fiber sensor receiving a reflected light from the printing paper surface.

16. A printing paper regeneration apparatus as set forth in claim 1, which further comprises a printing portion for printing information again on the printing paper regenerated by said printing paper regeneration processing portion.

17. A printing paper regeneration apparatus as set forth in claim 16, wherein said paper feeding portion has a detection mechanism for detecting presence and absence of print on the printing paper surface, and said apparatus further comprises a direct feeding mechanism for directly feeing the printing paper to said printing portion bypassing said printing paper regeneration processing portion when said detection mechanism detects absence of print on the printing paper surface.
